(19) United States
(12) Patent Application Publication
(10) Pub. No.: US 2009/0319908 A1
(43) Pub. Date: Dec. 24, 2009

(54) Website and network system for commercial establishments

(76) Inventors: Steven J. Hummel, Grand Rapids, MI (US); William Allen Whitmire, III, Grand Rapids, MI (US)

Correspondence Address: Rohm & Monsanto, PLC, 12 Rathbone Place, Grosse Pointe, MI, 48230, US

(21) Appl. No.: 12/387,964

(22) Filed: May 8, 2009

Related U.S. Application Data
(60) Provisional application No. 61/126,908, filed on May 8, 2008.

(51) Int. Cl. G06F 3/00

(52) U.S. Cl. 715/739

(57) ABSTRACT

A website and social network system where Customers, such as bars and entertainment venues, use an account interface through which management of the venue can enter and control contact information, daily specials, and upcoming events that are displayed to viewers of the Website System and to viewers of a viewer interface (widget). The Customers are also able to send instant messages to viewers of the Website System to an interface (widget) and to Members of the network from a customer account to the Members' e-mail, or via instant messaging, or with the use of cellular telephone text messaging. Customer promotional information is controllable directly by the Customer on multiple remote advertising websites simultaneously via the Website System and/or Customers' mobile devices.

### RELATIONSHIP TO OTHER APPLICATION

This application claims the benefit of the filing date of U.S. Provisional Patent Application Ser. No. 61/126,908, Filed May 8, 2008, the disclosure of which is incorporated herein by reference.

### BACKGROUND OF THE INVENTION

### Field of the Invention

This invention relates to a website and network system (“Website System”) where customers, such as bars and entertainment venues, pay a fee to have the use of an account interface through which management of the venue is able to enter and control contact information, daily specials, and upcoming events that are displayed to viewers of the Website System and to viewers of a viewer interface (widget). Customers also pay for access to data stored on the Website System and the ability to send instant messages to viewers of the Website System to an interface (widget) and to Members of the network from a customer account to the Members' e-mail, site specific instant messaging and Member cellular phone text messaging.

### SUMMARY OF THE INVENTION

In accordance with the invention, there is provided a system operated by a Vendor for promoting to a User the venue and events of a Customer. In accordance with the invention, the system is provided with a customer interface that accepts communications from the Customer. The communications include Customer data provided by the Customer relative to the Customer's venue and events conducted therein. A control system is operated by the Vendor, the control system being arranged to exchange information with the Customer via the customer interface. There is additionally provided a first data memory region for receiving and storing the Customer data in response to the control system. A user interface accepts communications from the User, the communications including User data provided by the User. Also, a second data memory region is provided for receiving and storing the User data in response to the control system. A selected portion of the Customer data is retrieved by the control system from the first data memory region and transmitted to the User via the user interface.

In one embodiment of the invention, the selected portion of the Customer data is transmitted to the User via the internet. In an alternative embodiment, the selected portion of the Customer data is transmitted to the User via a wireless mobile system.

In a highly advantageous embodiment, there is further provided the transmission of User mobile address data to the Customer to enable direct communication between the Customer and a mobile unit of the User. In the event that the User is pre-registered as a Member, a portion of the User data is obtained during a Member registration process.

In a further embodiment, there is provided an advertising port coupled to the control system for transmitting advertising material to a remote advertising website. The content of the advertising material is controlled by the Customer. Preferably, there are provided a plurality of remote advertising websites, and editing of the content of the advertising material by the Customer at the control system is immediately reflected on each remote advertising website. An advertising sites memory region for stores advertising websites data that identifies the plurality of remote advertising websites and correlates each such remote advertising website to a Customer.

In a further embodiment, there is provided a venues memory region that stores venues data that identifies each of a plurality of venues correlated to corresponding regional information, for presentation to the Users.

In the practice of an advantageous embodiment of the invention, the Users communicate with the user interface via the internet. Alternatively, in a further embodiment the Users communicate with the user interface via a viewer interface on a remote networking website.

In accordance with a further system aspect of the invention, there is provided a system that is operated by a Vendor for promoting to a User the venue and events of a Customer. A vendor website has a data memory with a plurality of data regions. A customer interface enables communication by a Customer with the vendor website. Customer information that is contained in the communication is stored in a customer data region of the data memory. There is additionally provided a user interface for enabling communication by a User with the vendor website. A control processor determines whether the User is a Member or a Guest. The control processor directs a Member to a member log-in process and to a member page stored in a data region of the data memory. A Guest, on the other hand, is directed to a vendor home page that is stored in a corresponding data region of the data memory. The control processor causes selected customer data to be posted on the vendor home page and selected member data to be provided to the customer interface.

In one embodiment of this further system aspect of the invention, selected customer information is transmitted in response to the control processor to remote advertising websites. Also, in some embodiments, selected customer information is transmitted directly to Members at addresses stored in the data memory. Such transmission of selected customer information to Members is effected via the internet, and in other embodiments via a wireless telecommunications system to mobile devices of the Members.

In a highly advantageous embodiment of the invention, customer promotional information is provided to a plurality of viewer interfaces on remote social networking websites. Revisions to the customer promotional information is, in some embodiments, reflected substantially immediately at the plurality of viewer interfaces on the remote social networking websites. In an advantageous embodiment of the invention, the customer promotional material that has been posted on the remote social networking websites is automatically removed from the viewer interfaces after a predetermined period of time.

In accordance with a still further system aspect of the invention, there is provided a system that is operated by a Vendor for promoting to a User the venue and events of a Customer. A vendor website has a data memory with a plurality of data regions. A customer interface enables communication by a Customer with the vendor website. Customer information contained in the communication is stored in a customer data region of the data memory. A user interface enables communication by a User with the vendor website. Also, there is provided a control processor, wherein the control processor:
determines whether the User is a Member or a Guest,
directs a Member to a member log-in process and to a member page stored in a data region of the data memory,
directs a Guest to a vendor home page stored in a corresponding data region of the data memory,
enables a Guest to register as a Member,
causes selected customer data to be posted on the vendor home page and selected member data to be provided to the customer interface,
causes transmission of customer promotional information to remote advertising websites, and
enables transmission of customer promotional information via a wireless telecommunications system to mobile devices of the Members.

### DEFINITIONS

“BarTag” is a photograph uploaded to the Website System by a Member and associated with another Member or with a Customer's venue.
“Buy Me a Drink” is a feature that allows Members to give prepaid food or beverage credits to other Members.
“Customer” is a commercial establishment that pays a fee to the Vendor for use of the features of the Website System.
“Customer Interface” is a login screen that allows Customers to control the content on the Website System pertaining to their venue, make payments to the Vendor, and send Red Light Specials.
“Drink Credit” is a coupon for a beverage that is redeemable at a Customer's venue.
“Guest” is a person who is viewing or otherwise using the Website System, but is not a Member.
“Member” is an individual who is has created an account on the Website System.
“PubCrawl” is a Member's itinerary for a given time that is self-promoted among the Members friends.
“Red Light Special” is an instant notification sent from a Customer to Users of the Website System and User Interface, notifying them of time specific promotions.
“SMS” is “short message service,” which is a protocol for communications on mobile devices.
“Users” are Members and Guests, collectively.
“User Interface” is an application (widget) that features content controlled by the Website System (i.e., the Vendor) and enables Users to interact with the content.
“Vendor” is the operator of the Website System of the present invention.
“Website System” is a website structured in accordance with the principles of the invention where Customers, which in some embodiments of the invention constitute bars, restaurants, and entertainment venues, pay a fee to access data stored on the website and/or use an account interface via which the management of the venue is enabled to enter and control, inter alia, contact information, daily specials, and upcoming events that are displayed to Users who view the Website System, and to Users who view a viewer interface (i.e., a widget).

Business Flow Features:

Guests and potential members are solicited to join the Website System by the following methods:
1) Promotion of the Website System on major search engines through submission of keywords and optimization
2) Promotion of the Website System on major search engines through paid sponsorship of predetermined keywords.
3) Publication of a Viewer Interface (widget) on Myspace.
4) Publication of a Viewer Interface (application) on Facebook.
5) Publication of a Viewer Interface on Google Gadgets.
6) Publication of a Viewer Interface on Yahoo Widgets.
7) Tools offered to Members allowing them to self-promote by inviting their friends to view and join the site and network.
8) Providing printed promotional material to Customers.
9) Inviting Members and Guests to send text messages (SMS) to the Vendor to receive a promotional offer.

### Features of the Website System:

1) A display that allows Guests and Members to enter their regional information, such as telephone area code or zip code, and receive information pertaining to and published by Customers specific to their region, including:
   a. Hours of operation
   b. Location
   c. Genre
   d. Phone numbers
   e. E-mail addresses
   f. Website Systems
   g. Daily specials
   h. Upcoming events
   I. Instant specials (Red Light specials)
2) The ability for Guests to log onto the website and become Members.
3) The ability for Guests and Members to view limited profiles of other Members broken down by region of interest, (e.g., area code or zip code).
4) The ability for Guests and Members to view limited profiles of other Members not broken down by region of interest.
5) The ability for Member to have customized pages that feature certain information about the Member including:
   a. Screen name
   b. Favorite venue
   c. Favorite beverage and food
   d. Short biography
   e. Photograph
6) The ability for Members to invite other Members to join their friends group (Entourage).
7) The ability for Members to send instant messages to other Members through site-specific communication features.
8) The ability for Members to notify specified groups of friends of their planned itinerary for any given day as it pertains to Customer's venues featured on the Website System (PubCrawl), through the following methods:
   a. E-mail.
   b. Instant messaging through site-specific communications.
   c. Text paging to cellular phone.
   d. Notification on Members page.
9) The ability for Members to send mass e-mails to their individual e-mail contacts and invite them to join the Website System.
10) The ability for Members to purchase Drink Credits online that are redeemable at Customers' venues.
11) The ability for Members to give Drink Credits to other Members (i.e., “Buy Me a Drink”).
12) The ability for Members to receive Drink Credits and redeem them at Customers venues.
13) The ability for Members to post comments about a Customer's venue.
14) The ability for Members to upload photographs pertaining to Customer(s) and other Members and associate the photograph with the Customer(s) and with the other Members. (i.e., “Bar Tagging”).

### Features of the SMS:

1) The Member is prompted by printed promotional literature or from a page on the Website System to send a text message to the Vendor's address to receive a special promotion.
2) The Website System will respond to the User's message by sending a mobile special back to the User's cellular handset in the form of a SMS message.
3) The SMS message will contain a question for the Users allowing them to select what notifications they would like to receive in the future regarding the selected venue
4) The SMS message will contain questions allowing a Guest to become a Member.

### Features of the Viewer Interface:

1) The ability to change regional data (i.e., area codes) and to receive information specific to that region.
2) A list of Customers featuring their daily specials.
3) An events calendar showing upcoming events sponsored by Customers.
4) A display of Red Light Specials in their region of interest.

### Features of the Customer Interface:

1) The ability for Customers to post daily specials on the Website System and on the Viewer Interface.
2) The ability for Customers to post upcoming events on the Website System and on the Viewer Interface
3) The ability for Customers to edit photographs that are uploaded by Members and associated with their venue.
4) The ability for Customers to edit comments that are uploaded by Members and associated with their venue.
5) The ability for Customers to post a logo on the site.
6) The ability for Customers to post a Red Light Special.
7) The ability for Customers to securely pay their bill to the Vendor.
8) The ability for Customers to post a SMS response.

Operation of the Website System:

The Vendor promotes the Website System and Viewer Interface through social networking sites and search engines. Guests view the Website System and Viewer Interface and opt to become Members. Members then promote the Website System through social networking tools provided by the Website System. Members grow their friends groups using the features provided by the Website System. A Member can have multiple friends groups (Entourages) that are associated with respective Customers (i.e., venues).

Members are attracted to the site by providing content in which they are interested from Customers about their local venues as well as posting information to their own profile pages, checking up on their friends profiles, using the PubCrawl, using BarTags, using Drink Credits, answering quizzes that are posted periodically, and chatting with their friends.

Customers are able to display promotional material prompting patrons to send a text message to the Vendors address containing a keyword that will cause the Website System to reply to the text message with a promotional offer for the Customer's Venue. The User's mobile contact information will then be stored by the Website System for use in future promotions.

Customers pay a fee to gain access to data stored on the Website System and/or to utilize the Customer Interface, provide content about their venues including daily specials and upcoming events, modify their profile page, post Red Light Specials, be able to accept Drink Credits, use the SMS feature, and potentially be part of a PubCrawl. Members will be notified of communications from Customers by email, Website System communications, text pages to cellular telephones, the Website System, and through the Viewer Interface. However, non-member Guests receive notifications only through the Website System and the Viewer Interface.

In accordance with a highly advantageous aspect of the invention, Customers pay a fee to use an interface on the Website System whereby Customers are permitted to enter information (either through the Website System directly or through an application on a mobile device). The information is then redistributed to a network of cellular (mobile) devices of Users who have opted to receive the information, and/or a network of viewer interfaces (widgets). The referenced interface additionally permits Users and Members to opt in to a selected customer's information stream by searching by name or browsing for customers by category.

In various embodiments of the invention, the Vendor will generate revenue by charging fees to Customers for access to data stored on the Website System and or the use of the Customer Interface, and may retain a percentage of all Drink Credits purchased on the Website System and by accepting fees for advertising on the site.

### BRIEF DESCRIPTION OF THE DRAWING

Comprehension of the invention is facilitated by reading the following detailed description, in conjunction with the annexed drawing, in which:

FIG. 1 is a schematic representation of a specific illustrative system for promoting Customer venues and events, as well as social networking among Members, configured in accordance with the principles of an embodiment of the invention;

FIG. 2 is a function block representation of a Website System constructed in accordance with the invention;

FIG. 3 is a function block representation of a specific illustrative embodiment of the inventive Website System of the present invention; and

FIG. 4 is a function block representation of a specific illustrative member registration procedure for use in an embodiment of the invention.

### DETAILED DESCRIPTION

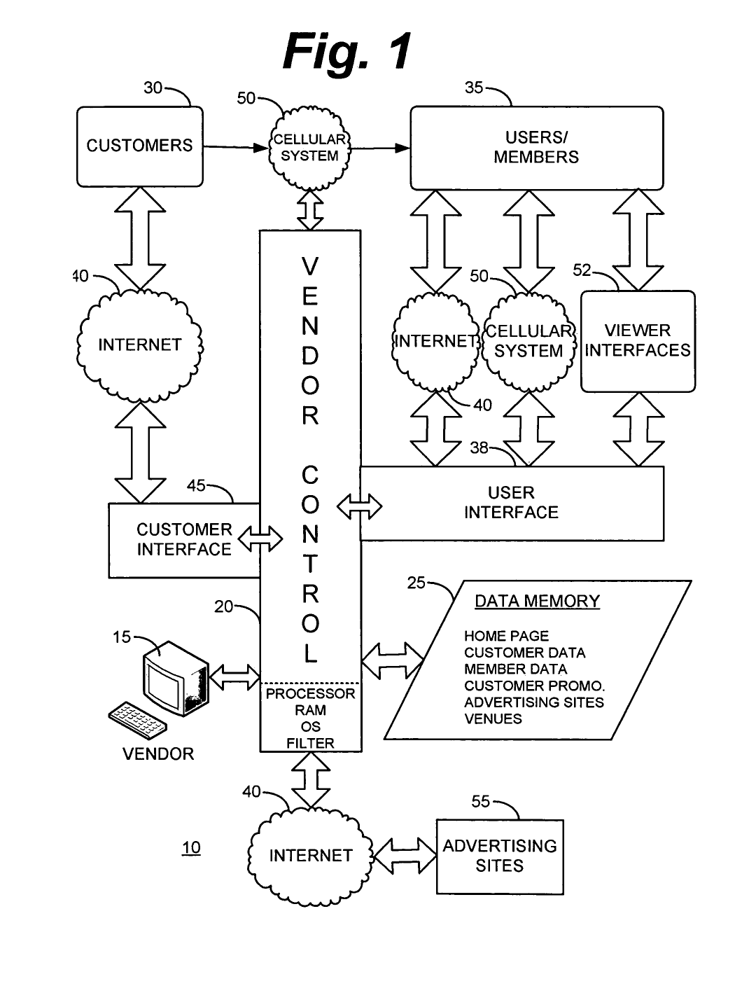

FIG. 1 is a schematic representation of a specific illustrative system for promoting Customer venues and events, as well as social networking among Members, configured in accordance with the principles of an embodiment of the invention. As shown in this figure, a server and website system 10 is operated by a Vendor 15 that control the system via a vendor control system 20. Vendor control system 20 is provided with a processor (not specifically designated), operating memory system (RAM) (not specifically designated), and an operating system (OS) (not specifically designated). In some embodiments, server and website system 10 is additionally provided with a filter that examines the language being used by Customers and optionally Users to exclude or otherwise control the use of profanity.

The vendor control system also has a data memory system 25 that contains a plurality of memory areas that are specific to the present embodiment of the invention. The memory areas of this specific illustrative embodiment of the invention include by way of example and without limitation:
Vendor home page(s) that are viewable by Users and Customers, as will be described below;
Customer data, including venue and events information relating to a multiplicity of customers;
Member data that has been entered by the Members on respective member pages (not shown in this figure) at the time of registration and as edited by the respectively associated Members thereafter;
Customer promotional information desired by the Customers to be distributed to selected ones of the Members and to advertising sites;
a listing of advertising sites in the form of web sites where advertising of Customers' venues and events, as well as Vendor promotional material, can be submitted for promotional purposes; and
a listing of venues (not necessarily Customers) with related geographical or area code data for presentation by the Vendor to the Members.

Customers 30 deliver information about their venues and events to Members 35 in this embodiment of the invention a variety of ways. Using internet 40, Customers 30 communicate with vendor control system 20 via a customer interface 45. The interface enables the Customers to post informational and promotional data in data memory 25, and to request of Vendor 15 that the data be presented to Users 35. The Vendor, using vendor control system 20 and a user interface 38, communicates the informational and promotional data to the Users via internet 40, using emails or instant massages, and/or via a cellular system 50 that transmits the data as text to the mobile devices (not shown) of the Users, particularly Members.

As will be described in greater detail below, Customer information is provided to viewer interfaces 52 on remote social networking websites (not shown in this figure). Such social networking websites include, for example, myspace.com, facebook.com, google.com, and yahoo.com.

In this specific illustrative embodiment of the invention, the informational and promotional data can be delivered directly to the Users by the Customers. In accordance with a particularly advantageous embodiment of the invention, Customers 30 communicate over cellular system 50 directly to the cellular or mobile devices (not shown) of the Members. The mobile addresses of the Members are obtained by the Customers, in this embodiment of the invention, from vendor control system 20.

In addition to the foregoing, informational and promotional data of the Customers, as well as promotional information of the Vendor, is advertised in this embodiment of the invention on advertising sites 55 pursuant to agreement (not shown) between the Vendors and the owner/operators (not shown) of advertising sites 55. In a specific illustrative embodiment of the invention, the Customer promotional information banner ad can exist on any web site that accepts advertisements. A portion of the banner ad displays text that is dynamically controlled by another source. In the practice of the invention, Customers pay for an account on the Vendor's site, and the Vendor provides the Customer with code for editing banner advertisement. The Customers can at anytime log-in to their account on the Vendor's site and change the advertising text. This will in turn change the text on all of the banner advertisements. In a specific illustrative embodiment of the invention, the Vendor can employ a content filter (not shown) that identifies and precludes the use of profanity. The addresses of the advertising sites are stored in data memory 25.

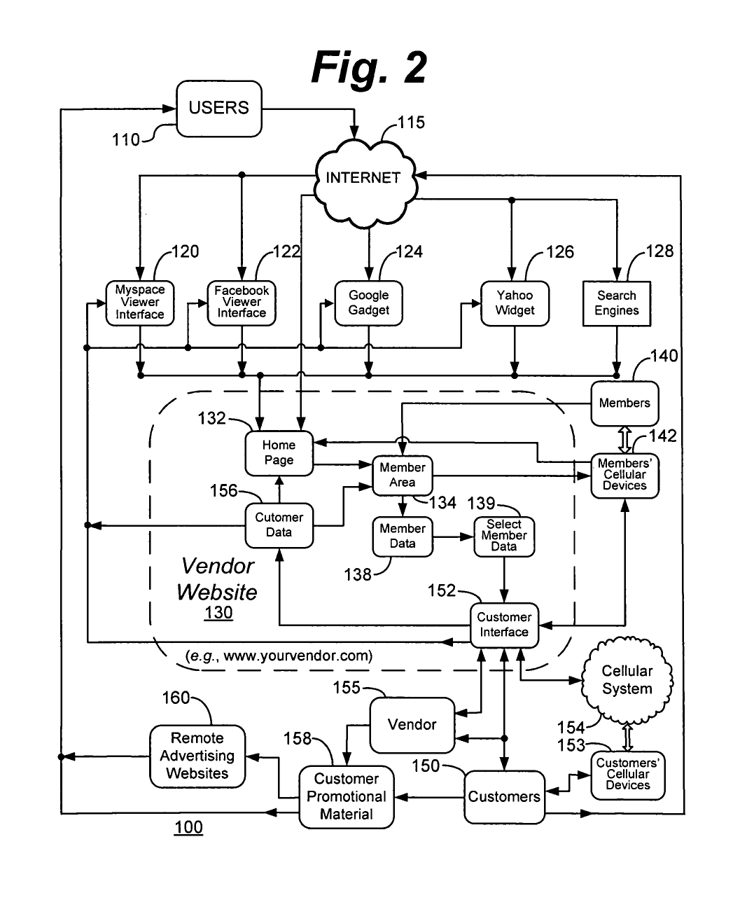

FIG. 2 is a function block representation of a Website System constructed in accordance with the invention. In the practice of the invention, Guests and Members, collectively, are Users, and therefore not all Users are Members.

As shown in this figure, a venue promotion system 100 enable access by Users 110 over the internet 115. A vendor website 130 is accessed by the User over the internet using, in this specific illustrative embodiment of the invention, any of internet 115 itself (e.g., a browser), a Myspace viewer interface 120, a Facebook viewer interface 122, a Google gadget 124, a Yahoo gadget 126, or any of several search engines 128. These available access and search facilities enable Users 110 to view and access home page 132 of vendor website 130, which in this embodiment of the invention is a web page stored in a memory (not shown) in a server system (not shown).

Members 140 access directly a member area 134, which also is a web page maintained in a memory region in the server system. As shown, such communication with the member area can, in this embodiment of the invention, be effected using a member's cellular device 142. Of course, the Members are able to access the member area using personal computers (not shown).

Customers 150 access a customer interface 152 after being permitted such access by Vendor 155. Customer interface 152 is a web page stored in a memory (not shown) and enables the Customers to access a customer data area 156, which is also a memory area in the server (not shown). Some of the information stored by the Customer in the customer data area is made available on home page 132 and made directly available to the Members, illustratively by wireless communication via member's cellular device 142. Thus, it is an advantageous feature of the present invention that Customers are able to communicate directly with Members. In addition to the foregoing, some of the information stored by the Customer in the customer data area is made available on any combination of Myspace viewer interface 120, a Facebook viewer interface 122, Google gadget 124, and Yahoo gadget 126.

More particularly, and in accordance with a highly advantageous aspect of the invention, Customers 150 pay a fee to use Customer Interface 152 on Website System 130 whereby the Customers are permitted to enter information either through Website System 130 directly or through an application on a mobile device, such as customers' cellular devices 153 using, for example, a cellular system 154. Irrespective of the form of communication between the Customer and Website System 130, the information posted by the Customer is available to Vendor 155. The information is then redistributed to a network of cellular (mobile) devices 142 of Members 140 who have opted to receive the information, and/or a network of viewer interfaces (widgets) (e.g., Myspace viewer interface 120, Facebook viewer interface 122, Google gadget 124, and Yahoo gadget 126). The referenced interface additionally permits Users and Members to opt in to a selected customer's information stream by searching by name or browsing for customers by category by using, for example, a search engine (e.g., search engine 128). In other embodiments, Customers pay a fee to gain access to selected member data 139 that is stored on Vendor Website 130.

In this embodiment of the invention, Customers 150, as well as Vendor 155, are able to generate customer promotional material 158 as data that is delivered directly to Users 110. Thus, the delivery of customer promotional material does not, in this embodiment of the invention, require that the Users access vendor website 130. In other embodiments, however, the customer promotional material is delivered to one or more remote advertising websites 160, and then is made available to Users 110. In the practice of this aspect of the invention in a specific illustrative embodiment, Customer 150 is enable to edit the customer promotional material, and the revisions to the customer promotional material are immediately reflected on Customer promotional information banner ads (not shown) on the remote advertising websites. In an advantageous embodiment of the invention, the customer promotional material that has been posted on the remote advertising websites is automatically removed from the viewer interfaces after a predetermined period of time.

Referring once again to vendor website 130, Members 140 communicate with member area 134. Users who access home page 132, once they are identified as Members, as will be discussed below, are enabled to access member area 134. In addition, some of the customer data in customer data area 156 is made available to the Members via member area 134. The Members, using member area 134, generate member data 138. A portion of the member data is selected at select member data function block 139 and delivered to customer interface 152.

In a highly advantageous embodiment of the invention, Members post information (member data 138) on their respective pages in the memory region (not shown) related to member area 134 that identifies their preferences in venues and activities. Additionally, Members include information that identifies the geographical region of interest, in the form of area code or zip code. Recognizing that a vendor website can be accessed nationally, and oftentimes internationally, such regional data enables the Customers to identify activities of interest within the region of interest. It is to be understood, however, that the regional data serves to improve the Member experience by focusing the attention of the Customers within the region of interest, but such regional date is not necessarily intended to limit the scope of the applicability of the invention to the Member or the Customer. For example, a Member is able to access information about Customers located at great distances from the region of interest, such as when the Member intends to travel to the distant region, or when the Member has an acquaintance in the distant region and desires to learn about the activities in which the acquaintance is engaged or to purchase for the acquaintance a “Buy Me A Drink” or a “Drink Credit.”

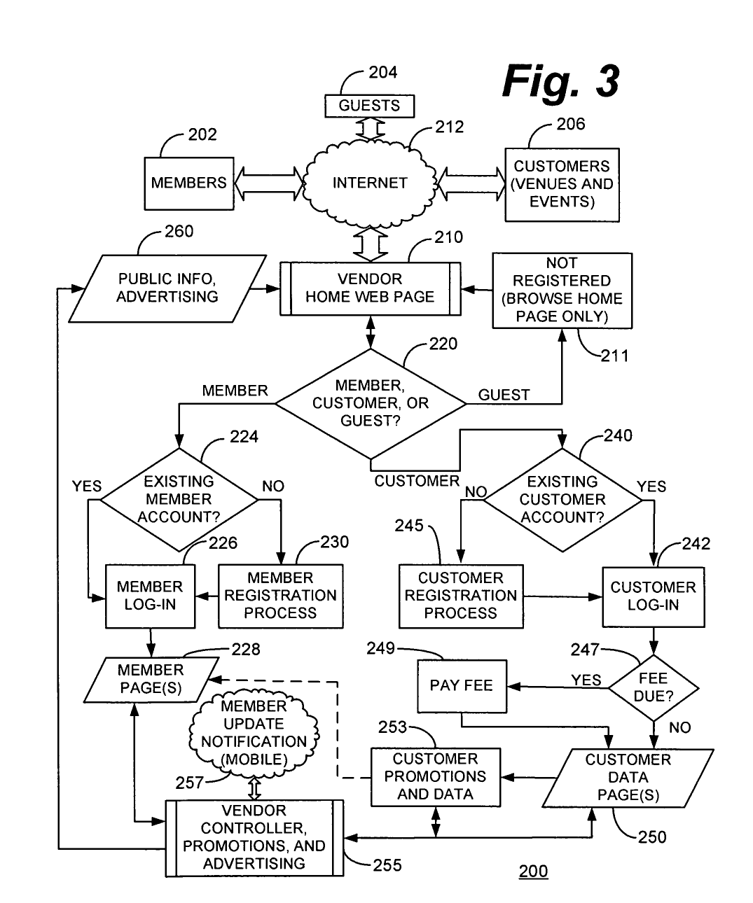

FIG. 3 is a function block representation of a specific illustrative embodiment of the inventive Website System of the present invention. As shown in this figure, a customer promotion system 200 is configured to enable Members 202, non-member Guests 204, and Customers 206 to access vendor home web page 210 via internet 212. A decision is made at decision block 220 whether the person accessing vendor home web page 210 is a Member, a Guest, or a Customer.

In accordance with this specific illustrative embodiment of the invention, if the person accessing vendor home web page 210 identifies himself or herself as a Member, a determination is made at decision function block 224 whether a corresponding member account has been activated. If so, the Member logs in at log-in function block 226 and is granted access to member web pages 228. If there is no corresponding member account in the corresponding memory area (not shown) of customer promotion system 200, the Member is registered using member registration process 230.

Further in accordance with this embodiment, if the person accessing vendor home web page 210 identifies himself or herself as a Customer, a determination is made at decision function block 240 whether a corresponding member account has been activated. If an active account is found in the system, the Customer is permitted to log-in at customer log-in process 242. However, if an active account is not found, the person accessing vendor home web page 210 is registered as a Customer at customer registration process 245. Upon completing the registration process, the Customer is permitted to log-on at customer log-in 242.

The system then determines whether a payment to the Vendor is owed by the Customer. This decision is made at fee decision block 247. If the Customer's account is current, whereby no fee is owed, the Customer is granted access to customer data pages 250. If a fee is owed, the fee is paid at fee payment process 249, and then the Customer is permitted to access customer data pages 250. In addition, in some embodiments the payment of the fee grants to the customer access to selected portions of the member data stored in the Website System in member pages 228 via vendor controller 255.

Once the Customer has logged-in and has been determined to be in good standing, Promotions and other information about the Customer are shown in customer promotions and data block 253, and in this specific illustrative embodiment of the invention, is made available directly to the Members via member pages 228. The Customer's promotional information is also provided to the Vendor at vendor controller 255. The Vendor, via vendor controller 255, is able to deliver the Customer's promotional information, as well as the Vendor's promotional information, to the Members via member pages 128.

In this embodiment of the invention, the Vendor, in addition to delivering promotional information to the Members via member 228, is able to deliver such information, as well as member update information, to the Members via mobile systems 257. Moreover, public information and advertising 260 can be posted by the Vendor directly to the Vendor's home web page (210), where it is viewed by any person over the internet (212), as described hereinabove and in relation to FIG. 2.

In the event that the person accessing vendor home web page 210 is a Guest, the Guest us not registered as either a Member or a Customer, but is permitted at function block 211 to browse home web page 210. Such a Guest, as noted above, would be able to view advertising as well as public information of the Vendor and the Customers. Of course, promotional information is posted on vendor home web page 210 that is directed toward inducing the Guest to become registered as a Member or a Customer.

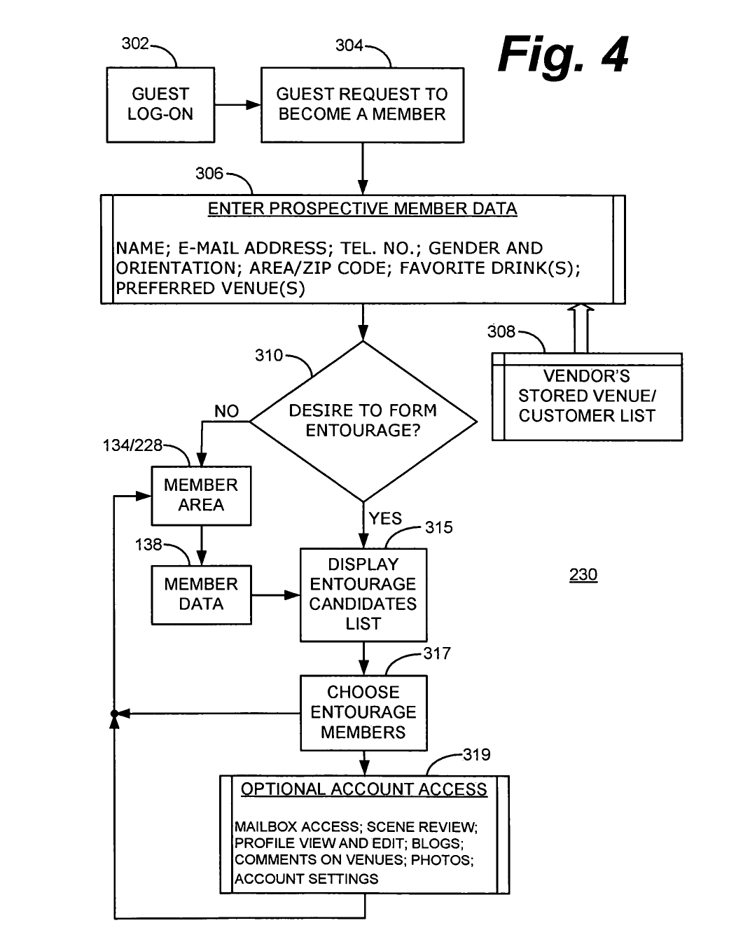

FIG. 4 is a function block representation of a specific illustrative member registration procedure 230 (see, FIG. 3) for use in an embodiment of the invention. Elements of structure and process steps that have previously been discussed are similarly designated. As shown in this figure, a non-member Guest logs-on to the system at log-on function block 302, and requests to be registered as a member at membership request function block 304.

The member registration process continues by requiring, in this embodiment of the invention, that the prospective member enter predetermined and optional member data at data entry function block 306. The data elements that are to be entered into the system include, for example, the prospective member's name; e-mail address; gender and orientation; area code; favorite drink(s); and a list of preferred venue(s). In a specific illustrative embodiment of the invention, the Vendor (not shown in this figure) will make available to the prospective member a regionally limited Venue/Customer list 308 of venues and Customers. Venue/Customer list 308 will facilitate the prospective member's venue selection.

In a specific illustrative embodiment of the invention, the new member is asked at decision block 310 whether he or she desires to form an entourage. If not, the new Member is directed to member area 134 (see, FIG. 2)/228 (see, FIG. 3). However, if the new member desires to form an entourage, a list of prospective entourage candidates is generated at function block 315 using the member data of function block 138. The listed prospective entourage members have, in this specific illustrative embodiment of the invention, regional proximity to the new member, as determined by same or nearby telephone area code. Alternatively, other regional information may be used in the practice of the invention, such as zip code, GPS data, venue selection, etc. Once the entourage participants have been selected at function block 317, the new member is directed to member area 134/228.

The new member is afforded the option of accessing and editing various aspects of his or her account and profile at editing function block 319. In one embodiment of the invention, some of the editing options made available to the new member include mailbox access; scene (venue) review; profile view and edit; blogs posting; comments on venues; upload photos; and change account settings.

Some of the features and functions of the system of the present invention are as follows:
1. Users 110 browse the internet 115.
2. Users are exposed to viewer interfaces on various websites (120, 122, 124, 126).
3. Users find the vendor website 130 (e.g., www.yourvendor.com) on search engines 128.
4. Viewer interfaces (120, 122, 124, 126) and search engines 128 link to the Website System (e.g., www.yourvendor.com)
5. Users can find the Website System by typing the URL (e.g., www.yourvendor.com) on their internet browser (not shown).
6. The website allows Users to become registered as Members (230).
7. Members volunteer certain data (139) that the Vendor keeps on the Website System and is made available to the Customers (152).
8. Select member contact data is summarized (139).
9. Customer interface 152 receives the summarized member contact data.
10. Customer data is provided directly to the Members via the Members' mobile devices 142.
11. Customer data is provided to the viewer interfaces (120, 122, 124, 126).
12. Customers use customer interface 152 to send Customer information to Viewer interfaces (120, 122, 124, 126).
13. Customer data is provided for posting on home page 132 of the Website.
14. Members access home page 132 on their cellular devices (142).
15. Customers use customer interface 152 to send text messages to Member's cellular devices.
16. Members receive selected data from the members' area 134 on their cellular devices 142.
17. Users connect to home page 132 of the Website System (e.g., www.yourvendor.com) from their cellular devices 142.
18. Customers pay a fee (249) to the Vendor, for the ability to use the Customer Interface and/or to gain access to data stored in the Website System.
19. Customers display material promoting their page to Members on the Website System (e.g., www.yourvendor.com).
20. Promotional material (255) is given to Customer by the Vendor
21. Users view promotional material (260).
22. Customer data (253) updates member area 228.
23. Member receives updates via cellular device (257).
24. Members view their personalized section (134, 228) of the website for updated customer information (156, 253).

Although the invention has been described in terms of specific embodiments and applications, persons skilled in the art can, in light of this teaching, generate additional embodiments without exceeding the scope or departing from the spirit of the invention described and claimed herein. Accordingly, it is to be understood that the drawing and description in this disclosure are proffered to facilitate comprehension of the invention, and should not be construed to limit the scope thereof.

What is claimed is:

1. A system operated by a Vendor for promoting to a User the venue and events of a Customer, the system comprising:
a customer interface for accepting communications from the Customer, the communications including Customer data provided by the Customer relative to the Customer's venue and events conducted therein;
a control system operated by the Vendor, said control system being arranged to exchange information with the Customer via said customer interface;
a first data memory region for receiving and storing the Customer data in response to said control system;
a user interface for accepting communications from the User, the communications including User data provided by the User;
a second data memory region for receiving and storing the User data in response to said control system;
wherein a selected portion of the Customer data is retrieved by said control system from said first data memory region and transmitted to the User via said user interface.

2. The system of claim 1, wherein the selected portion of the Customer data is transmitted to the User via the internet.

3. The system of claim 1, wherein the selected portion of the Customer data is transmitted to the User via a wireless mobile system.

4. The system of claim 1, wherein there is further provided the transmission of User mobile address data to the Customer to enable direct communication between the Customer and a mobile unit of the User.

5. The system of claim 1, wherein the User is pre-registered as a Member, and a portion of the User data is obtained during a Member registration process.

6. The system of claim 1, wherein there is further provided an advertising port coupled to said control system for transmitting advertising material to a remote advertising website.

7. The system of claim 6, wherein the content of the advertising material is controlled by the Customer.

8. The system of claim 6, wherein there are provided a plurality of remote advertising websites, and editing of the content of the advertising material by the Customer at said control system is immediately reflected on each remote advertising website.

9. The system of claim 8, wherein there is provided an advertising sites memory region for storing advertising websites data that identifies the plurality of remote advertising websites and correlates each such remote advertising website to a Customer.

10. The system of claim 1, wherein there is further provided a venues memory region for storing venues data that identifies each of a plurality of venues correlated to corresponding regional information, for presentation to the Users.

11. The system of claim 1, wherein Users communicate with said user interface via the internet.

12. The system of claim 11, wherein Users communicate with said user interface via a viewer interface on a remote networking website.

13. A system operated by a Vendor for promoting to a User the venue and events of a Customer, the system comprising:
a vendor website having a data memory with a plurality of data regions;
a customer interface for enabling communication by a Customer with said vendor website, customer information contained in the communication being stored in a customer data region of the data memory;
a user interface for enabling communication by a User with said vendor website; and
a control processor for determining whether the User is a Member or a Guest, said control processor directing a Member to a member log-in process and to a member page stored in a data region of the data memory, and directing a Guest to a vendor home page stored in a corresponding data region of the data memory, said control processor further causing selected customer data to be posted on the vendor home page and selected member data to be provided to said customer interface.

14. The system of claim 13, wherein selected customer information is transmitted in response to said control processor to remote advertising websites.

15. The system of claim 14, wherein selected customer information is transmitted directly to Members at addresses stored in the data memory.

16. The system of claim 15, wherein the transmission of selected customer information to Members is effected via the internet.

17. The system of claim 15, wherein the transmission of selected customer information to Members is effected via a wireless telecommunications system to mobile devices of the Members.

18. The system of claim 13, wherein customer promotional information is provided to a plurality of viewer interfaces on remote social networking websites.

19. The system of claim 18, wherein revisions to the customer promotional information is reflected substantially immediately at the plurality of viewer interfaces on the remote social networking websites.

20. A system operated by a Vendor for promoting to a User the venue and events of a Customer, the system comprising:
a vendor website having a data memory with a plurality of data regions;
a customer interface for enabling communication by a Customer with said vendor website, customer information contained in the communication being stored in a customer data region of the data memory;
a user interface for enabling communication by a User with said vendor website; and
a control processor;
wherein said control processor:
determines whether the User is a Member or a Guest,
directs a Member to a member log-in process and to a member page stored in a data region of the data memory,
directs a Guest to a vendor home page stored in a corresponding data region of the data memory,
enables a Guest to register as a Member,
causes selected customer data to be posted on the vendor home page and selected member data to be provided to said customer interface,
causes transmission of customer promotional information to remote advertising websites, and
enables transmission of customer promotional information via a wireless telecommunications system to mobile devices of the Members.
